(19) United States
(12) Patent Application Publication
(10) Pub. No.: US 2026/0087746 A1
(43) Pub. Date: Mar. 26, 2026

(54) METHOD OF GENERATING MODEL, SYSTEM FOR GENERATING MODEL, DEVICE, STORAGE MEDIUM, AND PROGRAM PRODUCT

(71) Applicant: SHANGHAI BINGZUO JINGYI TECHNOLOGY CO., LTD, Shanghai (CN)

(72) Inventors: Jihong ZHANG, Shanghai (CN); Ligang HE, Shanghai (CN); Longjun LI, Shanghai (CN)

(73) Assignee: SHANGHAI BINGZUO JINGYI TECHNOLOGY CO., LTD, Shanghai (CN)

(21) Appl. No.: 19/406,796

(22) Filed: Dec. 2, 2025

Related U.S. Application Data
(63) Continuation of application No. PCT/CN2025/088194, filed on Apr. 10, 2025.

(30) Foreign Application Priority Data
Apr. 29, 2024 (CN) 202410529722.X

(51) Int. Cl. G06T 19/00; G06T 7/12; G06T 7/73; G06T 17/00

(52) U.S. Cl. CPC G06T 19/00; G06T 7/12; G06T 7/73; G06T 17/00; G06T 2207/10132; G06T 2207/30048; G06T 2210/21; G06T 2210/41

(57) ABSTRACT

A method of generating a model includes the steps of: acquiring a plurality of ultrasound images of a target object and corresponding probing position information; extracting a contour feature point set of the target object in each of the ultrasound images, where the contour feature point set includes a plurality of contour feature points; obtaining spatial position information of each of the contour feature points based on the contour feature point set corresponding to each of the ultrasound images and the probing position information; obtaining a target projection point of each of the contour feature points on a standard three-dimensional model corresponding to the target object according to the spatial position information of each of the contour feature points.

### CROSS-REFERENCE TO RELATED APPLICATIONS

This application is a continuation of International Application No. PCT/CN2025/088194, filed on Apr. 10, 2025, which claims priority to Chinese Patent Application No. 202410529722.X, filed on Apr. 29, 2024. All of the aforementioned applications are incorporated herein by reference in their entireties.

### TECHNICAL FIELD

The present disclosure relates to the technical field of data processing, and in particular, to a method of generating a model, a system for generating a model, a device, a storage medium, and a program product.

### BACKGROUND

In intracardiac procedures, such as minimally invasive surgery for atrial fibrillation, a surgeon typically needs to use an Intracardiac Echocardiography (ICE) catheter to construct a three-dimensional model of part of the cardiac chambers before performing therapeutic operations. These three-dimensional models of the cardiac chambers can assist the surgeon in establishing three-dimensional spatial information among cardiac tissues and determining the relative position of surgical instruments within the cardiac chambers. The surgeon can also mark points on the three-dimensional model to record parts of the surgical procedure. Through the construction of the three-dimensional cardiac chamber model, the surgeon can plan surgical operations more accurately, navigate surgical instruments, locate lesion areas, and minimize surgical risks while improving the success rate of the surgery.

However, the current operation of constructing three-dimensional models using an ICE catheter still relies on manual processes. First, the operator needs to accurately manipulate the ICE handle to position the ICE probe at the desired location, then manually select an image from the cardiac diastole phase at that location, and gradually build the cardiac chamber model by tracing and outlining. This construction method is not only time-consuming, but the generated models also often have issues such as lacking accuracy and missing many details. Furthermore, the operator requires a high level of specialized knowledge to judge and select ultrasound images that are from suitable cardiac cycle phases and meet specific requirements.

### SUMMARY

The technical problem to be solved by the present disclosure is to overcome the defects in the prior art, such as the long time consumption and the coarseness and inaccuracy of models when using an ICE catheter to construct a three-dimensional cardiac chamber model, thereby providing a method of generating a model, a system for generating a model, a device, a storage medium, and a program product.

The present disclosure solves the above technical problem through the following technical solution.

According to a first aspect of the present disclosure, a method of generating a model is provided. The generation method includes the steps of:
acquiring a plurality of ultrasound images of a target object and corresponding probing position information;
extracting a contour feature point set of the target object in each of the ultrasound images, the contour feature point set comprising a plurality of contour feature points;
obtaining spatial position information of each of the contour feature points based on the contour feature point set corresponding to each of the ultrasound images and the probing position information;
obtaining a target projection point of each of the contour feature points on a standard three-dimensional model corresponding to the target object according to the spatial position information of each of the contour feature points; and
calibrating the standard three-dimensional model based on the spatial position information of each of the contour feature points and the target projection point, to obtain a target three-dimensional model of the target object.

Preferably, the step of obtaining the target projection point of each of the contour feature points on the standard three-dimensional model corresponding to the target object according to the spatial position information of each of the contour feature points includes:
acquiring an intersection point set of the contour feature point set corresponding to each of the ultrasound images with the standard three-dimensional model;
aligning the contour feature point set with the corresponding intersection point set using a preset alignment method based on the spatial position information; and
mapping each of the contour feature points in the aligned contour feature point set onto the standard three-dimensional model, to obtain the target projection point corresponding to each of the contour feature points.

Preferably, the step of acquiring the intersection point set of the contour feature point set corresponding to each of the ultrasound images with the standard three-dimensional model comprises:
creating a virtual sector surface of the contour feature point set based on the spatial position information and the corresponding probing position information;
acquiring the intersection point set of the virtual sector surface with the standard three-dimensional model;
wherein the step of aligning the contour feature point set with the corresponding intersection point set using the preset alignment method based on the spatial position information includes:

acquiring a first centroid position corresponding to the plurality of contour feature points in the contour feature point set, and a second centroid position corresponding to a plurality of intersection points in the intersection point set;
moving each of the contour feature points in the contour feature point set along the same direction by an identical displacement based on the first centroid position and the second centroid position, to align the contour feature point set with the corresponding intersection point set; and/or,
wherein the step of mapping each of the contour feature points in the aligned contour feature point set onto the standard three-dimensional model, to obtain the target projection point corresponding to each of the contour feature points includes:
mapping each of the contour feature points in the contour feature point set onto the standard three-dimensional model, to obtain an initial projection point corresponding to each of the contour feature points;
acquiring a distance between each of the contour feature points and the corresponding initial projection point, to obtain a total distance corresponding to the contour feature point set;
moving each of the contour feature points by an identical preset distance if the total distance does not satisfy a preset condition, to expand or contract the spatial position of each of the contour feature points;
repeating the step of mapping each of the contour feature points in the contour feature point set onto the standard three-dimensional model to obtain the initial projection point corresponding to each of the contour feature points, until the total distance satisfies the preset condition; and
using the initial projection point corresponding to each of the contour feature points as the target projection point.

Preferably, the step of calibrating the standard three-dimensional model based on the spatial position information of each of the contour feature points and the target projection point, to obtain the target three-dimensional model of the target object includes:
acquiring a nearest neighbor point of the target projection point on the standard three-dimensional model;
moving the nearest neighbor point to a position of each of the contour feature points corresponding to the target projection point based on the spatial position information;
acquiring a point set to be updated, the point set to be updated comprising points to be updated whose distance from the nearest neighbor point is less than a preset threshold; and
calibrating each of the points to be updated in the point set to be updated by using a preset algorithm, to obtain the target three-dimensional model.

Preferably, the step of calibrating each of the points to be updated in the point set to be updated by using the preset algorithm, to obtain the target three-dimensional model includes: acquiring an original point curvature of the standard three-dimensional model;
acquiring a curvature of each of the points to be updated in the point set to be updated, to obtain a calibrated point curvature of the point set to be updated;
calculating a target position of each of the points to be updated using a genetic algorithm that minimizes a difference between the calibrated point curvature and the original point curvature as an optimization objective; and
moving each of the points to be updated to the corresponding target position, to obtain the target three-dimensional model.

Preferably, the target object includes an entire target organ or an entire target tissue; and/or,
the target object includes a plurality of target parts included in the entire target organ or the entire target tissue;
the contour feature point set of the target object includes a sub-contour feature point set corresponding to each of the target parts;
wherein the step of obtaining the target projection point of each of the contour feature points on the standard three-dimensional model corresponding to the target object according to the spatial position information of each of the contour feature points includes:
acquiring all sub-contour feature point sets corresponding to the same target part, and the spatial position information corresponding to the sub-contour feature point set;
obtaining a sub-projection point of each of sub-contour feature points on a sub-standard three-dimensional model corresponding to the target parts based on the sub-contour feature point set and the spatial position information;
wherein the step of calibrating the standard three-dimensional model based on the spatial position information of each of the contour feature points and the target projection point, to obtain the target three-dimensional model of the target object includes:
calibrating the sub-standard three-dimensional model corresponding to the target parts based on the spatial position information of each of the sub-contour feature points corresponding to the target parts and the sub-projection point, to obtain a sub-three-dimensional model of each of the target parts; and
obtaining the target three-dimensional model of the target object based on the sub-three-dimensional model of each of the target parts.

Preferably, the entire target organ or the entire target tissue includes a heart; and
each of the target parts includes a left atrium, a left ventricle, a right atrium, a right ventricle, an aorta, a pulmonary artery, and a superior vena cava.

According to a second aspect of the present disclosure, a system for generating a model is provided. The generation method includes an acquisition module, an extraction module, a mapping module, a projection module, and a calibration module;
the acquisition module is configured to acquire a plurality of ultrasound images of a target object and corresponding probing position information;
the extraction module is configured to extract a contour feature point set of the target object in each of the ultrasound images, the contour feature point set comprising a plurality of contour feature points;
the mapping module is configured to obtain spatial position information of each of the contour feature points based on the contour feature point set corresponding to each of the ultrasound images and the probing position information;
the projection module is configured to obtain a target projection point of each of the contour feature points on a standard three-dimensional model corresponding to the target object according to the spatial position information of each of the contour feature points;
the calibration module is configured to calibrate the standard three-dimensional model based on the spatial position information of each of the contour feature points and the target projection point, to obtain a target three-dimensional model of the target object.

Preferably, the projection module includes an acquisition unit, an alignment unit, and a mapping unit;
the acquisition unit is configured to acquire an intersection point set of the contour feature point set corresponding to each of the ultrasound images with the standard three-dimensional model;
the alignment unit is configured to align the contour feature point set with the corresponding intersection point set using a preset alignment method based on the spatial position information; and
the mapping unit is configured to map each of the contour feature points in the aligned contour feature point set onto the standard three-dimensional model, to obtain the target projection point corresponding to each of the contour feature points.

Preferably, the acquisition unit includes a creation sub-unit and an acquisition sub-unit, and the alignment unit includes a centroid determination sub-unit and an alignment sub-unit;
the creation sub-unit is configured to create a virtual sector surface of the contour feature point set based on the spatial position information and the corresponding probing position information;
the acquisition sub-unit is configured to acquire the intersection point set of the virtual sector surface with the standard three-dimensional model;
the centroid determination sub-unit is configured to acquire a first centroid position corresponding to the plurality of contour feature points in the contour feature point set, and a second centroid position corresponding to a plurality of intersection points in the intersection point set;
the alignment sub-unit is configured to move each of the contour feature points in the contour feature point set along the same direction by an identical displacement based on the first centroid position and the second centroid position, to align the contour feature point set with the corresponding intersection point set;
and/or,
the mapping unit includes a mapping sub-unit, a distance sub-unit, an adjustment sub-unit, and a determination sub-unit;
the mapping sub-unit is configured to map each of the contour feature points in the contour feature point set onto the standard three-dimensional model, to obtain an initial projection point corresponding to each of the contour feature points;
the distance sub-unit is configured to acquire a distance between each of the contour feature points and the corresponding initial projection point, to obtain a total distance corresponding to the contour feature point set;
the adjustment sub-unit is configured to move each of the contour feature points by an identical preset distance if the total distance does not satisfy a preset condition, to expand or contract the spatial position of each of the contour feature points;
the mapping sub-unit is invoked to repeatedly perform the step of mapping each of the contour feature points in the contour feature point set onto the standard three-dimensional model to obtain the initial projection point corresponding to each of the contour feature points, until the total distance satisfies the preset condition; and
the determination sub-unit is configured to use the initial projection point corresponding to each of the contour feature points as the target projection point.

Preferably, the calibration module includes an extraction unit, a movement unit, and a calibration unit;
the extraction unit is configured to acquire a nearest neighbor point of the target projection point on the standard three-dimensional model;
the movement unit is configured to move the nearest neighbor point to a position of each of the contour feature points corresponding to the target projection point based on the spatial position information;
the extraction unit is further configured to acquire a point set to be updated, the point set to be updated comprising points to be updated whose distance from the nearest neighbor point is less than a preset threshold; and
the calibration unit is configured to calibrate each of the points to be updated in the point set to be updated by using a preset algorithm, to obtain the target three-dimensional model.

Preferably, the calibration unit includes an original curvature calculation sub-unit, a calibrated curvature calculation sub-unit, an optimization sub-unit, and a movement sub-unit;
the original curvature calculation sub-unit is configured to acquire an original point curvature of the standard three-dimensional model;
the calibrated curvature calculation sub-unit is configured to acquire a curvature of each of the points to be updated in the point set to be updated, to obtain a calibrated point curvature of the point set to be updated;
the optimization sub-unit is configured to calculate a target position of each of the points to be updated using a genetic algorithm that minimizes a difference between the calibrated point curvature and the original point curvature as an optimization objective; and
the movement sub-unit is configured to move each of the points to be updated to the corresponding target position, to obtain the target three-dimensional model.

Preferably, the target object includes an entire target organ or an entire target tissue; and/or,
the target object includes a plurality of target parts included in the entire target organ or the entire target tissue;
the contour feature point set of the target object includes a sub-contour feature point set corresponding to each of the target parts;
the projection module is further configured to: acquire all sub-contour feature point sets corresponding to the same target part, and the spatial position information corresponding to the sub-contour feature point set; and obtain a sub-projection point of each of sub-contour feature points on a sub-standard three-dimensional model corresponding to the target parts based on the sub-contour feature point set and the spatial position information; and
the calibration module is further configured to: calibrate the sub-standard three-dimensional model corresponding to the target parts based on the spatial position information of each of the sub-contour feature points corresponding to the target parts and the sub-projection point, to obtain a sub-three-dimensional model of each of the target parts; and obtain the target three-dimensional model of the target object based on the sub-three-dimensional model of each of the target parts.

Preferably, the entire target organ or the entire target tissue includes a heart; and
each of the target parts includes a left atrium, a left ventricle, a right atrium, a right ventricle, an aorta, a pulmonary artery, and a superior vena cava.

According to a third aspect of the present disclosure, an electronic device is provided. The electronic device includes a memory, a processor, and a computer program stored on the memory and configured to be executed by the processor, wherein the processor implements the generation method according to the first aspect of the present disclosure when executing the computer program.

According to a fourth aspect of the present disclosure, a computer-readable storage medium is provided. The computer-readable storage medium has a computer program stored thereon, wherein the computer program implements the generation method according to the first aspect of the present disclosure when executed by a processor.

According to a fifth aspect of the present disclosure, a computer program product is provided. The computer program product includes a computer program, wherein the computer program implements the generation method according to the first aspect of the present disclosure when executed by a processor.

On the basis of being consistent with common knowledge in the art, the various preferred conditions mentioned above can be combined arbitrarily to obtain the various preferred embodiments of the present disclosure.

The present disclosure provides the following positive effects. By combining global information of a standard cardiac model with local information of intracardiac echocardiography images, and adopting a genetic algorithm to rapidly fit a patient-specific cardiac three-dimensional model, rapid construction of the cardiac three-dimensional model during a surgical procedure is achieved. This rapid construction enables an ICE catheter operator to automatically complete operations such as ultrasound image selection and three-dimensional model construction without requiring additional manual intervention, significantly shortens the time required to construct the cardiac three-dimensional model before surgery, greatly simplifies the workflow of the ICE catheter operator, and reduces surgical risks.

### BRIEF DESCRIPTION OF THE DRAWINGS

FIG. 1 is a flowchart of a method of generating a model according to Embodiment 1 of the present disclosure.

FIG. 2 is a flowchart of step S4 of the method of generating a model according to Embodiment 1 of the present disclosure.

FIG. 3 is a schematic diagram of the image distribution of an intersection point set according to Embodiment 1 of the present disclosure.

FIG. 4 is a first schematic diagram of alignment processing between a contour feature point set and the intersection point set according to Embodiment 1 of the present disclosure.

FIG. 5 is a second schematic diagram of alignment processing between the contour feature point set and the intersection point set according to Embodiment 1 of the present disclosure.

FIG. 6 is a flowchart of step S43 of the method of generating a model according to Embodiment 1 of the present disclosure.

FIG. 7 is a flowchart of step S5 of the method of generating a model according to Embodiment 1 of the present disclosure.

FIG. 8 is a flowchart of step S54 of the method of generating a model according to Embodiment 1 of the present disclosure.

FIG. 9 is a flowchart of an algorithm according to Embodiment 1 of the present disclosure.

FIG. 10 is a modular schematic diagram of a system for generating a model according to Embodiment 2 of the present disclosure.

FIG. 11 is a structural schematic diagram of an electronic device according to Embodiment 3 of the present disclosure.

### DETAILED DESCRIPTION OF THE EMBODIMENTS

The present disclosure is further illustrated below through embodiments, but the present disclosure is not thereby limited to the scope of the described embodiments.

In the embodiments of the present disclosure, the use of prefix terms such as “first” and “second” is only intended to distinguish different described objects and has no limiting effect on the position, order, priority, quantity, or content of the described objects. The use of prefix terms such as ordinal numbers in the embodiments of the present disclosure to distinguish described objects does not constitute a limitation on the described objects. Statements regarding the described objects refer to the descriptions in the claims or the context of the embodiments and should not be construed as imposing unnecessary limitations due to the use of such prefix terms. Furthermore, in the description of the present embodiments, unless otherwise specified, “a plurality of” means two or more.

The following describes an exemplary application of a computer-implemented model generation method according to an embodiment of the present disclosure. The computer-implemented model generation method provided by the embodiment of the present disclosure may be implemented in a terminal or implemented in a server. In an embodiment, the computer-implemented model generation method provided by the embodiment of the present disclosure may be implemented in various types of terminals such as a laptop computer, a tablet computer, a desktop computer, or a mobile device. In another embodiment, the computer-implemented model generation method provided by the embodiment of the present disclosure may also be implemented in a server. The server may be an independent physical server, a server cluster or a distributed system composed of a plurality of physical servers, or a cloud server that provides basic cloud computing services such as cloud services, cloud databases, cloud computing, cloud functions, cloud storage, network services, cloud communication, middleware services, domain name services, security services, Content Delivery Network (CDN), big data, and artificial intelligence platforms. The terminal and the server may be connected directly or indirectly via wired or wireless communication, which is not limited in the embodiment of the present disclosure. In the following embodiments, an exemplary application where the computer-implemented model generation method is implemented in a server will be described.

In the embodiments of the present disclosure, the collection, storage, use, processing, transmission, provision, and disclosure of involved user personal information are all performed in compliance with the provisions of relevant laws and regulations and do not violate public order and good morals.

### Embodiment 1

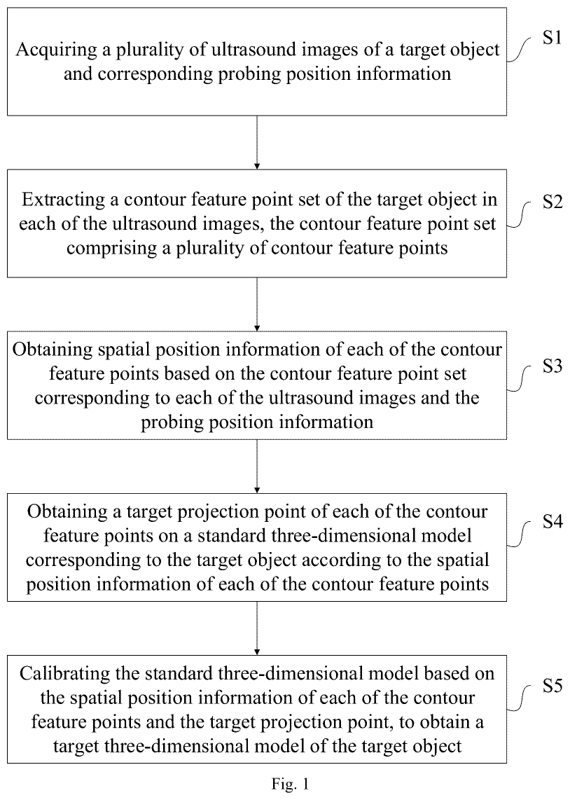

In a specific embodiment of the present disclosure, a method of generating a model is provided. As shown in FIG. 1, the generation method includes the steps of:
S1, acquiring a plurality of ultrasound images of a target object and corresponding probing position information by an acquisition device.

The acquisition device may include an image acquisition unit, a position sensing unit, and a data interface and acquisition card.

The image acquisition unit, such as an ultrasound probe, is a device that directly generates raw ultrasound data. The ultrasound probe scans the target object (e.g., an organ, a fetus, etc.) via sound waves.

The position sensing unit, such as a position sensor, may be an electromagnetic sensor, an optical tracker (e.g., a camera capturing reflective markers), or an Inertial Measurement Unit (IMU) mounted on the ultrasound probe. These components track the position and orientation (i.e., the “probing position information”) of the ultrasound probe in three-dimensional space in real time.

The data interface and acquisition card is configured to receive signals from the position sensor and ultrasound image data from the ultrasound probe, and convert these signals into digital signals processable by a computing device.
S2, extracting a contour feature point set of the target object in each of the ultrasound images by an extraction device, the contour feature point set comprising a plurality of contour feature points.

The extraction device may include a Central Processing Unit (CPU) and/or a Graphics Processing Unit (GPU), which serve as the core for executing the task of “extracting a contour feature point set of the target object in each of the ultrasound images, the contour feature point set comprising a plurality of contour feature points”. This utilizes image processing libraries (e.g., OpenCV) and computer vision algorithms (e.g., edge detection, contour finding, neural network segmentation, etc.) to automatically identify and extract feature points of the target contour.
S3, obtaining spatial position information of each of the contour feature points by a spatial position determination device based on the contour feature point set corresponding to each of the ultrasound images and the probing position information.

The spatial position determination device may include a CPU. The CPU performs a mathematical transformation (typically involving coordinate transformation and projective geometry) to convert the 2D feature points (pixel coordinates) in the image with the 3D spatial position and orientation of the probe when that image was acquired. Through this transformation, the CPU calculates a “point on the image” into a “point in real three-dimensional space.”
S4, obtaining a target projection point of each of the contour feature points on a standard three-dimensional model corresponding to the target object by a projection point determination device according to the spatial position information of each of the contour feature points.

The projection point determination device may include a CPU and a storage device (e.g., a hard disk or memory). The CPU executes a search or projection algorithm. The CPU searches for positions on the surface of the standard three-dimensional model that best match the spatially acquired feature points. For example, the CPU may perform a perpendicular projection of real facial feature points onto the surface of a standard facial model, or find corresponding points on the model via a closest point search algorithm (part of the Iterative Closest Point (ICP) algorithm steps).
S5, calibrating the standard three-dimensional model by a model calibration device based on the spatial position information of each of the contour feature points and the target projection point, to obtain a target three-dimensional model of the target object.

The model calibration device may include a CPU and a GPU. This step involves calculating a set of deformation functions or parameters to pull the “target projection points” on the standard model as close as possible to the real acquired “spatial position information” points. This can be achieved through non-rigid registration algorithms, Thin Plate Spline (TPS) interpolation, or physics-based deformation models. Finally, the entire standard model undergoes smooth and reasonable deformation according to the movement of these control points, thereby generating a customized and precise “target three-dimensional model.”

Specifically, to achieve rapid construction of the target three-dimensional model, a standard three-dimensional model of the target object needs to be pre-constructed. Herein, the target object includes the entire target organ or the entire target tissue. For example, taking the entire heart organ as an example, the standard three-dimensional model of the heart can be obtained by collecting cardiac scan data from a plurality of patients via external ultrasound, Computed Tomography (CT), and Magnetic Resonance Imaging (MRI), constructing cardiac three-dimensional models using a three-dimensional reconstruction algorithm, and obtaining an average shape model of the various cardiac three-dimensional models using a statistical shape model construction method. Herein, the three-dimensional reconstruction algorithm can use a voxel-based volume reconstruction method and/or a contour point-based surface reconstruction method. When constructing the statistical shape model, a Fourier Decomposition method may be employed, or a method of constructing Point Distribution Models may be used.

In step S1, by using an internal ultrasound device (for example, an ICE catheter), a plurality of ultrasound images D={D₁, D₂, . . . , Dₙ} of the target object can be acquired, and simultaneously, a probing position information matrix L={L₁, L₂, . . . , Lₙ} corresponding to each of the ultrasound images is recorded. For example, the target object can be a heart. Ultrasound images of the heart during the isovolumic relaxation phase and corresponding probing position information are acquired using the ICE catheter. The probing position information can be provided by the hardware probe itself, or can be inferred and predicted based on an intracardiac probe position model. This embodiment does not impose specific limitations in this regard.

After acquiring the plurality of ultrasound images, step S2 performs ultrasound image contour extraction and contour structure edge processing on each of the ultrasound images to obtain the contour of the target object in each of the ultrasound images. Herein, each contour consists of a plurality of contour feature points, and these contour feature points collectively form a contour feature point set corresponding to that contour.

For example, the cardiac contour is extracted from each of the ultrasound images, and then through edge processing, the complete contour feature point set C={C₁, C₂, . . . , Cₘ} of the heart can be obtained, where each contour has one and only one corresponding probe position. Each contour consists of a cluster of contour feature points, thus Cᵢ=Pᵢ={p₁, p₂, . . . , pᵤ}, where Pᵢ is the two-dimensional point set of the contour feature point set Cᵢ, and pᵤ is the u-th point on the contour Cᵢ. The value of pᵤ can be expressed as pᵤ=(xᵤ, yᵤ, 0.0, 0.0).

Since each of the ultrasound images is a two-dimensional image, the two-dimensional image needs to be transformed into three-dimensional space to obtain three-dimensional spatial information of the target object. Therefore, step S3 transforms each of the contour feature points into a representation in three-dimensional space according to the contour feature point set corresponding to each of the ultrasound images and the probing position information. For example, taking point pᵤ as an example, pᵤ is multiplied by the 4×4 probing position information matrix Lᵢ corresponding to Cᵢ to obtain the expression of pᵤ in three-dimensional space, namely pᵤ′=pᵤ×Lᵢ. Similarly, by multiplying all points in the contour feature point set corresponding to the target object by the probing position information matrix corresponding to the contour to which the points belong, the expression of the entire target object contour in three-dimensional space can be obtained.

After obtaining the spatial information of each of the contour feature points in the target object, step S4 maps each of the contour feature points onto the standard three-dimensional model corresponding to the target object to obtain a target projection point of each of the contour feature points on the standard three-dimensional model. Subsequently, step S5 calibrates the standard three-dimensional model based on the spatial position information and the target projection point of each of the contour feature points, to rapidly fit and obtain the target three-dimensional model of the target object.

This specific embodiment rapidly fits a patient-specific cardiac three-dimensional model by establishing a standard three-dimensional model of the heart and utilizing contour edge data of part of the heart collected from ultrasound images to fit and approximate the standard three-dimensional model to the patient's actual heart shape, thereby achieving rapid construction of the cardiac three-dimensional model during the surgical procedure. Consequently, an ICE catheter operator can automatically complete operations such as ultrasound image selection and three-dimensional model construction without requiring additional manual intervention, thereby significantly shortening the time required to construct the cardiac three-dimensional model before surgery.

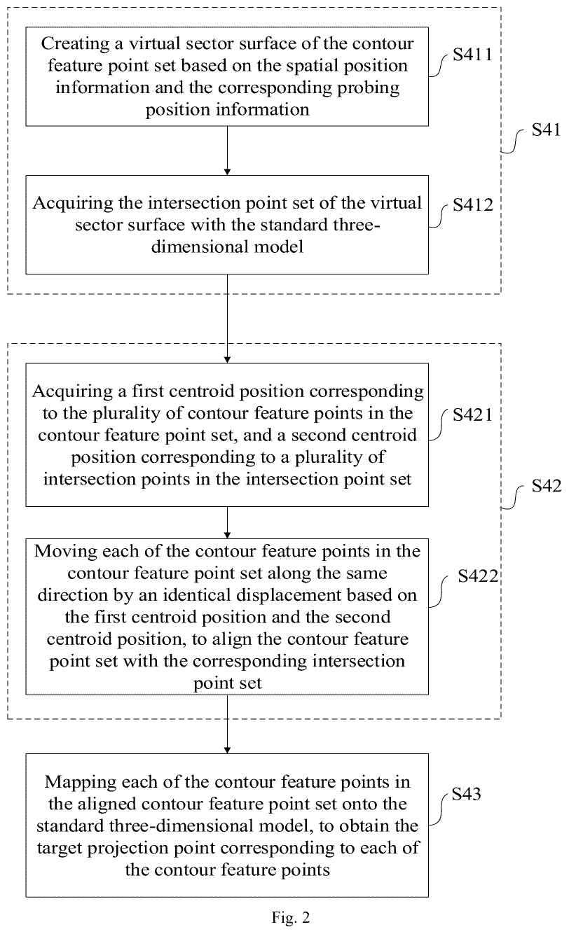

In a specific embodiment, as shown in FIG. 2, step S4 includes the steps of:
S41, acquiring an intersection point set of the contour feature point set corresponding to each of the ultrasound images with the standard three-dimensional model;
S42, aligning the contour feature point set with the corresponding intersection point set using a preset alignment method based on the spatial position information; and
S43, mapping each of the contour feature points in the aligned contour feature point set onto the standard three-dimensional model, to obtain the target projection point corresponding to each of the contour feature points.

Step S41 includes the steps of:
S411, creating a virtual sector surface of the contour feature point set based on the spatial position information and the corresponding probing position information; and
S412, acquiring the intersection point set of the virtual sector surface with the standard three-dimensional model.

Step S42 includes the steps of:
S421, acquiring a first centroid position corresponding to the plurality of contour feature points in the contour feature point set, and a second centroid position corresponding to a plurality of intersection points in the intersection point set; and
S422, moving each of the contour feature points in the contour feature point set along the same direction by an identical displacement based on the first centroid position and the second centroid position, to align the contour feature point set with the corresponding intersection point set.

Specifically, global alignment and local alignment methods may be utilized respectively to perform alignment processing between the contour feature points obtained through step S3 and the standard three-dimensional model.

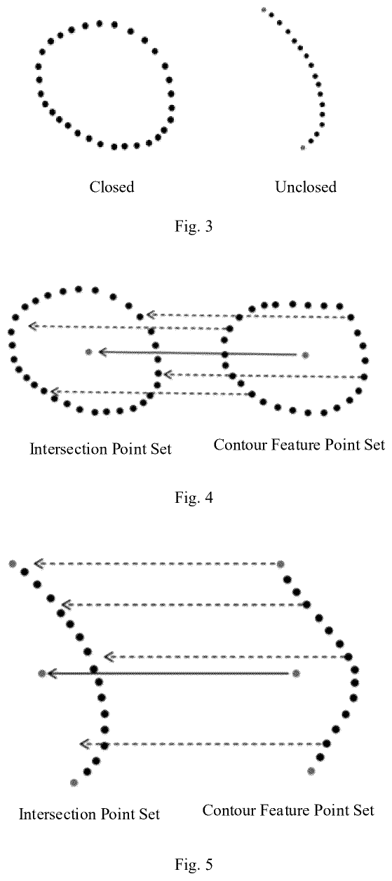

For example, through step S3, the overall point set C={C₁, C₂, . . . , Cₘ} of the contour feature point set C and its corresponding probing position information matrix L={L₁, L₂, . . . , Lₙ} are acquired. Thus, for a contour feature point set Cⱼ, there is one and only one corresponding probing position information matrix Lⱼ. Using the probing position information matrix Lⱼ, a virtual sector surface F corresponding to the contour feature point set Cⱼ can be created. This virtual sector surface F intersects the standard three-dimensional model LA, thereby obtaining an intersection point set I between the contour feature point set Cⱼ and the standard three-dimensional model LA. At this point, the image distribution of the intersection point set may be closed or unclosed, as shown in FIG. 3.

When the image distribution of the intersection point set is closed, that is, when the distance between any two points in the intersection point set is less than a threshold θ, the global alignment method may be used. This comprises moving the centroid of the contour feature point set Cⱼ to the centroid position of the intersection point set I. Simultaneously, all points in the contour feature point set Cⱼ will move by the identical displacement as the centroid, as shown in FIG. 4.

When the image distribution of the intersection point set is unclosed, that is, when the distance between two points in the intersection point set is greater than or equal to the threshold θ, the local alignment method may be used. This comprises moving the midpoint of the two endpoints of the contour feature point set Cⱼ to the midpoint position of the two endpoints of the intersection point set I. Similarly, all points in the contour feature point set Cⱼ will move by the identical displacement as the endpoint midpoint, as shown in FIG. 5. Herein, the endpoints are determined based on the number of adjacent points; for example, when an endpoint has one and only one adjacent point within a range q, that point is considered one of the endpoints of the contour feature point set.

Similarly, by performing the aforementioned alignment processing steps on all contour feature point sets C of the target object, an aligned complete contour point set C′ relative to the standard three-dimensional model is obtained.

Through step S43, each of the contour feature points in each aligned contour feature point set is mapped onto the standard three-dimensional model, thereby obtaining a target projection point of each of the contour feature points on the standard three-dimensional model.

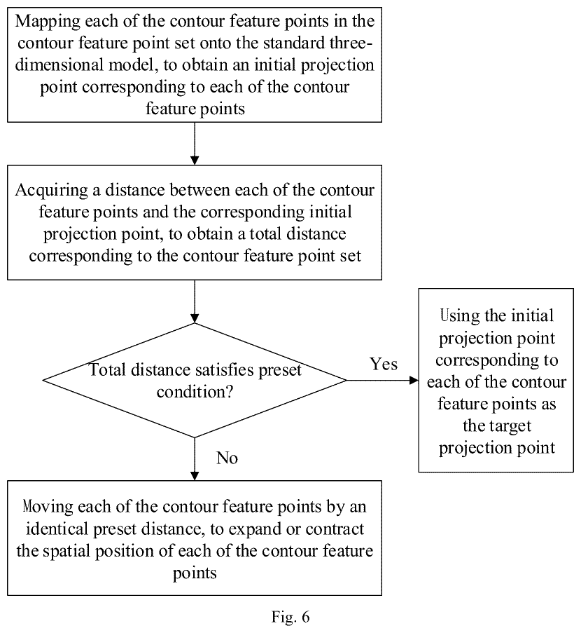

In a specific embodiment, as shown in FIG. 6, step S43 includes the steps of:
S431, mapping each of the contour feature points in the contour feature point set onto the standard three-dimensional model, to obtain an initial projection point corresponding to each of the contour feature points;
S432, acquiring a distance between each of the contour feature points and the corresponding initial projection point, to obtain a total distance corresponding to the contour feature point set;
S433, moving each of the contour feature points by an identical preset distance if the total distance does not satisfy a preset condition, to expand or contract the spatial position of each of the contour feature points;
repeating the step S431, until the total distance satisfies the preset condition;
S434, using the initial projection point corresponding to each of the contour feature points as the target projection point.

Specifically, the ultrasound depth is adjustable. As the depth value increases, the visible tissue within the fixed-size image sector surface becomes smaller, and the imaging content increases; whereas as the depth value decreases, the visible tissue within the image sector surface becomes larger and more detailed. After the alignment processing through step S42, the overall bounding box size of the contour feature points needs to be converged to the size range of the bounding box of the standard three-dimensional model.

Therefore, in one specifically implementable manner, step S431 may project each of the contour feature points onto the surface of the standard three-dimensional model to obtain an initial projection point of each of the contour feature points on the standard three-dimensional model. Since the contour feature points may be located outside the standard three-dimensional model (for example, if the patient's heart is larger) or inside the standard three-dimensional model (for example, if the patient's heart is smaller), when a contour feature point is outside the standard three-dimensional model, the initial projection point can be obtained by the intersection of the line connecting the contour feature point to the centroid/midpoint position point with the surface of the standard three-dimensional model; when the contour feature point is inside the standard three-dimensional model, a ray is drawn from the centroid/midpoint position point to the contour feature point, and the extension line of this ray will intersect the surface of the standard three-dimensional model, thereby obtaining the initial projection point.

Subsequently, step S432 acquires the distance between each of the contour feature points and the corresponding initial projection point, and calculates the sum of distances. Then, step S433 performs overall scaling to minimize this sum of distances. Herein, when the contour feature points are outside the standard three-dimensional model, the sum of distances is reduced by overall scaling down; when the contour feature points are inside the standard three-dimensional model, the sum of distances is reduced by overall scaling up. Through multiple adjustments, the sum of distances is minimized. Thereafter, step S434 adopts the initial projection point corresponding to each of the contour feature points when the sum of distances is minimized as the target projection point.

In a specific embodiment, a parameter a is determined to minimize the distance between the contour feature point set C′ and its projection points on the standard three-dimensional model. Thus, the projection points C″=αC′ of the patient's actual cardiac contour in the three-dimensional space of the standard three-dimensional model are obtained. Specifically, through step S42, the aligned contour feature point set Cⱼ′ is obtained. Let point set Q be the projection of the contour feature point set Cⱼ′ on the standard three-dimensional model. The parameter a can be determined such that argmin f(x)=Σ(αCⱼ′−Q), thus yielding Cⱼ″=αCⱼ′.

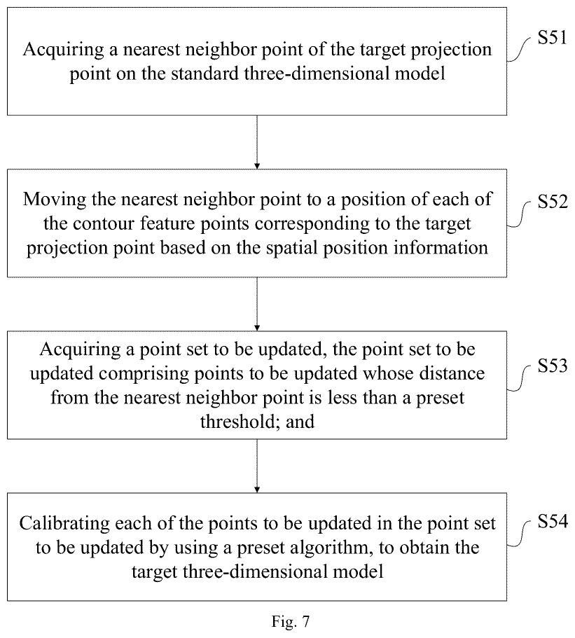

In a specific embodiment, as shown in FIG. 7, step S5 includes the steps of:
S51, acquiring a nearest neighbor point of the target projection point on the standard three-dimensional model;
S52, moving the nearest neighbor point to a position of each of the contour feature points corresponding to the target projection point based on the spatial position information;
S53, acquiring a point set to be updated, the point set to be updated comprising points to be updated whose distance from the nearest neighbor point is less than a preset threshold; and
S54, calibrating each of the points to be updated in the point set to be updated by using a preset algorithm, to obtain the target three-dimensional model.

Specifically, through step S4, projection points of the patient's actual cardiac contour on the standard cardiac three-dimensional model can be obtained. Since the projection points are virtual points rather than physical points, step S51 is required to acquire nearest neighbor points of these projection points on the standard cardiac three-dimensional model. While maintaining the topological structure of the model unchanged, step S52 moves the positions of these nearest neighbor points to the positions of the corresponding projection points, thereby obtaining a modified cardiac model. For example, the nearest neighbor point Q′ of the patient's cardiac projection point P″ on the standard cardiac three-dimensional model is determined, and then the positional coordinates of these points are set to be identical to the projection points, i.e., Q′=P″, obtaining the displacement vector V=P″-Q′ for these points.

Subsequently, with the updated positions of the nearest neighbor points locked, step S53 acquires points to be updated on the standard three-dimensional model whose distance from the nearest neighbor points is less than a preset threshold. Step S54 then utilizes a preset algorithm to determine new positions for the points to be updated, and moves the points to be updated to the corresponding new positions to obtain the target three-dimensional model. For example, after obtaining the displacement vector V between the nearest neighbor point Q′ and the projection point P″, a near-geodesic method is used to acquire the point set to be updated PB within a neighboring distance less than β from the projection point set P″.

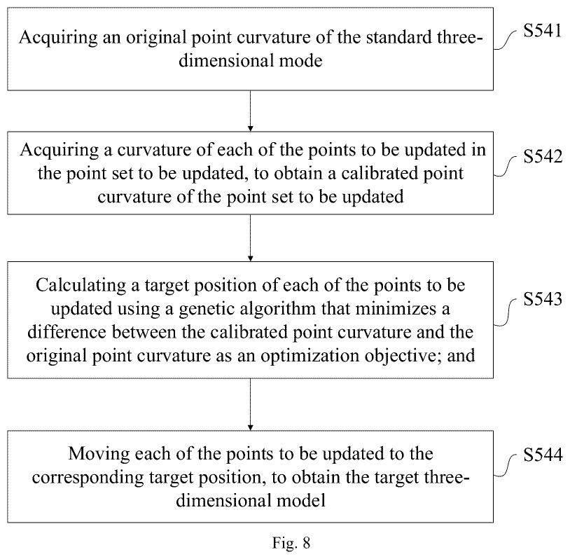

In a specific embodiment, as shown in FIG. 8, step S54 includes the steps of:
S541, acquiring an original point curvature of the standard three-dimensional model;
S542, acquiring a curvature of each of the points to be updated in the point set to be updated, to obtain a calibrated point curvature of the point set to be updated;
S543, calculating a target position of each of the points to be updated using a genetic algorithm that minimizes a difference between the calibrated point curvature and the original point curvature as an optimization objective; and
S544, moving each of the points to be updated to the corresponding target position, to obtain the target three-dimensional model.

Specifically, in a three-dimensional model, curvature refers to the degree of bending or the radius of curvature at a point on a surface. Curvature describes the local geometric characteristics of the surface in the vicinity of that point. The magnitude of curvature is directly proportional to the degree of bending of the surface, and the radius of curvature represents the reciprocal of the curvature. Herein, if the radius of curvature is small, the surface bends more significantly near that point; if the radius of curvature is large, the surface is relatively flat.

Therefore, to simultaneously obtain the cardiac shape information from the standard cardiac three-dimensional model and the real-time information of the patient's actual cardiac contour, cardiac shape information can be assessed using maximum curvature, Gaussian curvature, and mean curvature. Taking mean curvature as an example, the positions of the nearest neighbor points can be fixed, and the positions of the points to be updated can be adjusted to minimize the total mean curvature change between the new model and the original model. The objective is argmin f(X)={X|∀Y: f(X)≤f(Y)}, where X and Y are distributions of model points, and f(X) and f(Y) are the total mean curvature changes under the point distributions X and Y, respectively.

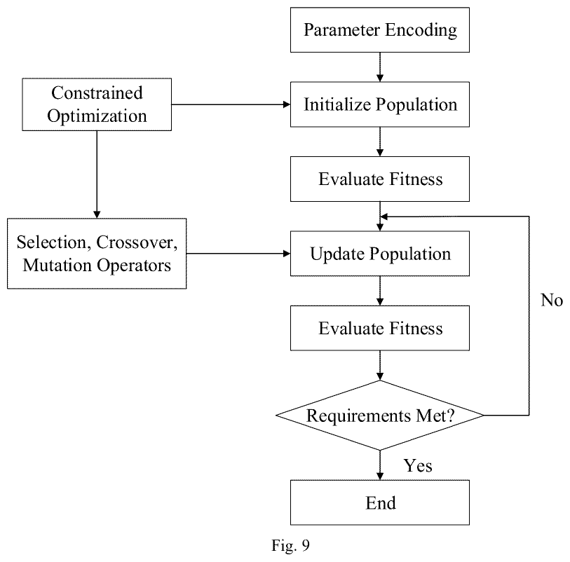

To solve the aforementioned single-objective optimization problem, a genetic algorithm for constrained optimization can be utilized. The algorithm flowchart is shown in FIG. 9. The process mainly includes parameter encoding, initializing the population, evaluating fitness, and updating the population through selection, crossover, and mutation operators. In the constrained optimization rules, there are two conditions: 1) only the points to be updated in the projection point set of the patient's actual cardiac contour undergo position updates; 2) the direction vector for the position updates of these points to be updated equals the sum of the parameters of the displacement vectors of the projection point set.

For example, after obtaining the displacement vector V and the point set to be updated PB, given that the number of points in the point set to be updated PB is w, a point to be updated pb is adjacent to w_{pb} points in the projection point set P″, and the displacement vectors of these points are V′. According to the constrained optimization rules, the update direction of the point to be updated pb satisfies the following formula:

$${T}_{pb} = λ {V}^{′} = {λ}_{1} {V}_{1}^{′} = {λ}_{2} {V}_{2}^{′} + ⋯ + {λ}_{{w}_{pb}} {V}_{{w}_{pb}}^{′}$$

Herein, T_{pb} is the update direction for the point to be updated pb, λ is the distance weight vector, the vector length of λ is w_{pb}, and the value range is [0, γ]. Accordingly, based on the length w and the value range [0, γ], the initial population GW₀ can be encoded and randomly initialized. Then, based on the update direction of the projection point set PB for each member in the population, the updated cardiac three-dimensional model and its total mean curvature change are obtained. The total mean curvature changes for each member in the population are sorted in ascending order. The top N members serve as parent members, and the diversity of the population members is increased through crossover and mutation operations, resulting in the next generation group GW₁.

Using the aforementioned sorting, selection, crossover, and mutation operations as a cycle, the loop terminates when the top N members no longer update, finally yielding a result that satisfies the optimization objective.

In a specific embodiment, the target object includes a plurality of target parts included in the entire target organ or the entire target tissue;

the contour feature point set of the target object includes a sub-contour feature point set corresponding to each of the target parts;

Step S4 includes the steps of:
acquiring all sub-contour feature point sets corresponding to the same target part, and the spatial position information corresponding to the sub-contour feature point set; and
obtaining a sub-projection point of each of sub-contour feature points on a sub-standard three-dimensional model corresponding to the target parts based on the sub-contour feature point set and the spatial position information;

Step S5 includes the steps of:
calibrating the sub-standard three-dimensional model corresponding to the target parts based on the spatial position information of each of the sub-contour feature points corresponding to the target parts and the sub-projection point, to obtain a sub-three-dimensional model of each of the target parts; and
obtaining the target three-dimensional model of the target object based on the sub-three-dimensional model of each of the target parts.

Specifically, taking the heart as an example, the heart comprises a plurality of target parts. These target parts include the left atrium, the left ventricle, the right atrium, the right ventricle, the aorta, the pulmonary artery, and the superior vena cava. When extracting the contour feature point sets of the target object from each of the ultrasound images in step S2, an image segmentation algorithm can be utilized to perform semantic segmentation of the ultrasound images. This enables accurate segmentation between different cardiac chambers. Subsequently, through contour structure edge processing, the edges of the cardiac chamber contours are extracted, and interfering components at the edges of the ultrasound image sector surface are removed, ultimately obtaining the true cardiac chamber edges and thereby obtaining the sub-contour feature point set corresponding to each of the target parts. The image segmentation algorithm can be a deep learning-based image segmentation method or a traditional image threshold segmentation method.

When constructing the cardiac three-dimensional model, corresponding three-dimensional models are constructed for the different parts of the heart. It is to be understood that the standard three-dimensional model includes sub-standard three-dimensional models corresponding to the various parts. Taking the left atrium as an example, the left atrial contour is acquired from each of the ultrasound images. Based on the probing position information of each of the ultrasound images, the spatial position information corresponding to each of the left atrial contour feature points is obtained. Each left atrial contour is mapped onto the left atrial sub-standard three-dimensional model, and the left atrial sub-standard three-dimensional model is calibrated to obtain the sub-three-dimensional model corresponding to the left atrium. The specific calibration process can be referred to in other embodiments. By analogy, after obtaining the sub-three-dimensional models corresponding to the various target parts of the heart, the target three-dimensional model of the entire heart can be acquired.

This specific embodiment, by constructing corresponding sub-three-dimensional models for the various target parts of the target object, can completely represent the characteristic details of each of the target parts, more closely fit the actual shape of the patient's target object, and facilitate accurate judgment and assessment by the physician.

This embodiment, by combining global information of a standard cardiac model with local information of intracardiac echocardiography images, and adopting a genetic algorithm to rapidly fit a patient-specific cardiac three-dimensional model, achieves rapid construction of the cardiac three-dimensional model during a surgical procedure. This rapid construction enables an ICE catheter operator to automatically complete operations such as ultrasound image selection and three-dimensional model construction without requiring additional manual intervention, significantly shortens the time required to construct the cardiac three-dimensional model before surgery, greatly simplifies the workflow of the ICE catheter operator, and reduces surgical risks.

### Embodiment 2

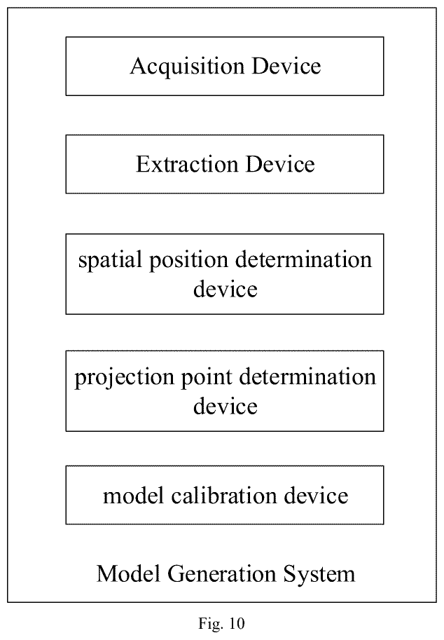

FIG. 10 is a modular schematic diagram of a system for generating a model according to an exemplary embodiment of the present disclosure, wherein the generation system includes an acquisition device 100, an extraction device 200, a spatial position determination device 300, a projection point determination device 400, and a model calibration device 500;
the acquisition device 100 is configured to acquire a plurality of ultrasound images of a target object and corresponding probing position information;
the extraction device 200 is configured to extract a contour feature point set of the target object in each of the ultrasound images, the contour feature point set comprising a plurality of contour feature points;
the spatial position determination device 300 is configured to obtain spatial position information of each of the contour feature points based on the contour feature point set corresponding to each of the ultrasound images and the probing position information;
the projection point determination device 400 is configured to obtain a target projection point of each of the contour feature points on a standard three-dimensional model corresponding to the target object according to the spatial position information of each of the contour feature points;
the model calibration device 500 is configured to calibrate the standard three-dimensional model based on the spatial position information of each of the contour feature points and the target projection point, to obtain a target three-dimensional model of the target object.

In a specific embodiment, the projection point determination device 400 includes an acquisition unit, an alignment unit, and a mapping unit;
the acquisition unit is configured to acquire an intersection point set of the contour feature point set corresponding to each of the ultrasound images with the standard three-dimensional model;
the alignment unit is configured to align the contour feature point set with the corresponding intersection point set using a preset alignment method based on the spatial position information; and
the mapping unit is configured to map each of the contour feature points in the aligned contour feature point set onto the standard three-dimensional model, to obtain the target projection point corresponding to each of the contour feature points.

In a specific embodiment, the acquisition unit includes a creation sub-unit and an acquisition sub-unit, and the alignment unit includes a centroid determination sub-unit and an alignment sub-unit;
the creation sub-unit is configured to create a virtual sector surface of the contour feature point set based on the spatial position information and the corresponding probing position information;
the acquisition sub-unit is configured to acquire the intersection point set of the virtual sector surface with the standard three-dimensional model;
the centroid determination sub-unit is configured to acquire a first centroid position corresponding to the plurality of contour feature points in the contour feature point set, and a second centroid position corresponding to a plurality of intersection points in the intersection point set; and

the alignment sub-unit is configured to move each of the contour feature points in the contour feature point set along the same direction by an identical displacement based on the first centroid position and the second centroid position, to align the contour feature point set with the corresponding intersection point set.

In a specific embodiment, the mapping unit includes a mapping sub-unit, a distance sub-unit, an adjustment sub-unit, and a determination sub-unit;
the mapping sub-unit is configured to map each of the contour feature points in the contour feature point set onto the standard three-dimensional model, to obtain an initial projection point corresponding to each of the contour feature points;
the distance sub-unit is configured to acquire a distance between each of the contour feature points and the corresponding initial projection point, to obtain a total distance corresponding to the contour feature point set;
the adjustment sub-unit is configured to move each of the contour feature points by an identical preset distance if the total distance does not satisfy a preset condition, to expand or contract the spatial position of each of the contour feature points;
the mapping sub-unit is invoked to repeatedly perform the step of mapping each of the contour feature points in the contour feature point set onto the standard three-dimensional model to obtain the initial projection point corresponding to each of the contour feature points, until the total distance satisfies the preset condition; and
the determination sub-unit is configured to use the initial projection point corresponding to each of the contour feature points as the target projection point.

In a specific embodiment, the model calibration device 500 includes an extraction unit, a movement unit, and a calibration unit;
the extraction unit is configured to acquire a nearest neighbor point of the target projection point on the standard three-dimensional model;
the movement unit is configured to move the nearest neighbor point to a position of each of the contour feature points corresponding to the target projection point based on the spatial position information;
the extraction unit is further configured to acquire a point set to be updated, the point set to be updated comprising points to be updated whose distance from the nearest neighbor point is less than a preset threshold; and
the calibration unit is configured to calibrate each of the points to be updated in the point set to be updated by using a preset algorithm, to obtain the target three-dimensional model.

In a specific embodiment, the calibration unit includes an original curvature calculation sub-unit, a calibrated curvature calculation sub-unit, an optimization sub-unit, and a movement sub-unit;
the original curvature calculation sub-unit is configured to acquire an original point curvature of the standard three-dimensional model;
the calibrated curvature calculation sub-unit is configured to acquire a curvature of each of the points to be updated in the point set to be updated, to obtain a calibrated point curvature of the point set to be updated;
the optimization sub-unit is configured to calculate a target position of each of the points to be updated using a genetic algorithm that minimizes a difference between the calibrated point curvature and the original point curvature as an optimization objective; and
the movement sub-unit is configured to move each of the points to be updated to the corresponding target position, to obtain the target three-dimensional model.

In a specific embodiment, the target object includes an entire target organ or an entire target tissue.

In a specific embodiment, the target object includes a plurality of target parts included in the entire target organ or the entire target tissue;
the contour feature point set of the target object includes a sub-contour feature point set corresponding to each of the target parts;
the projection point determination device 400 is further configured to: acquire all sub-contour feature point sets corresponding to the same target part, and the spatial position information corresponding to the sub-contour feature point set; and obtain a sub-projection point of each of sub-contour feature points on a sub-standard three-dimensional model corresponding to the target parts based on the sub-contour feature point set and the spatial position information; and
the model calibration device 500 is further configured to: calibrate the sub-standard three-dimensional model corresponding to the target parts based on the spatial position information of each of the sub-contour feature points corresponding to the target parts and the sub-projection point, to obtain a sub-three-dimensional model of each of the target parts; and obtain the target three-dimensional model of the target object based on the sub-three-dimensional model of each of the target parts.

In a specific embodiment, the entire target organ or the entire target tissue includes a heart; and
each of the target parts includes a left atrium, a left ventricle, a right atrium, a right ventricle, an aorta, a pulmonary artery, and a superior vena cava.

With regard to the system embodiment, since the system embodiment substantially corresponds to the method embodiment, reference may be made to relevant descriptions in the method embodiment for corresponding parts. The system embodiments described above are merely illustrative. The units described as separate components may or may not be physically separated. Components designated as units may or may not be physical units; that is, the components may be located in one place, or may be distributed across multiple network units. Some or all of the devices may be selected according to actual needs to achieve the objectives of the solutions of the present disclosure.

This embodiment, by combining global information of a standard cardiac model with local information of intracardiac echocardiography images, and adopting a genetic algorithm to rapidly fit a patient-specific cardiac three-dimensional model, achieves rapid construction of the cardiac three-dimensional model during a surgical procedure. This rapid construction enables an ICE catheter operator to automatically complete operations such as ultrasound image selection and three-dimensional model construction without requiring additional manual intervention, significantly shortens the time required to construct the cardiac three-dimensional model before surgery, greatly simplifies the workflow of the ICE catheter operator, and reduces surgical risks.

### Embodiment 3

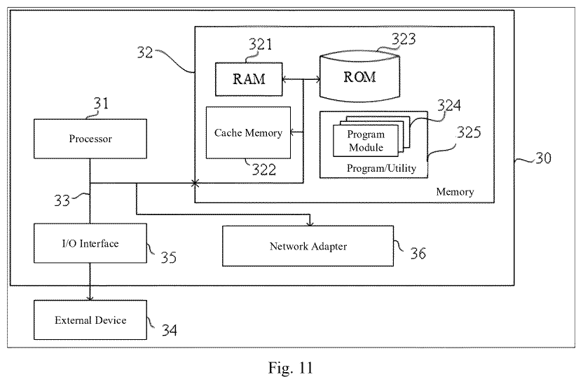

FIG. 11 is a structural schematic diagram of an electronic device according to an exemplary embodiment of the present disclosure. The electronic device includes a memory, a processor, and a computer program stored on the memory and configured to be executed by the processor, wherein the processor implements the generation method according to any of the foregoing embodiments when executing the computer program. The electronic device 30 shown in FIG. 11 is merely an example and should not impose any limitation on the functions and scope of use of the embodiments of the present disclosure.

As shown in FIG. 11, the electronic device 30 may be embodied as a general-purpose computing device; for example, the electronic device 30 may be a server device. Components of the electronic device 30 may include, but are not limited to: the at least one processor 31, the at least one memory 32, and a bus 33 connecting different system components, including the memory 32 and the processor 31.

The bus 33 includes a data bus, an address bus, and a control bus.

The memory 32 may include a volatile memory, such as a random access memory (RAM) 321 and/or a cache memory 322, and may further include a read-only memory (ROM) 323.

The memory 32 may also include a program/utility 325 having a set of (at least one) program modules 324. Such program modules 324 include, but are not limited to: an operating system, one or more application programs, other program modules, and program data. Any one or a combination of these examples may include an implementation of a network environment.

The processor 31 executes various functional applications and performs data processing by running the computer program stored on the memory 32, thus executing the model generation method provided in any of the foregoing embodiments, for example.

The electronic device 30 may also communicate with one or more external devices 34 (e.g., a keyboard, a pointing device, etc.). This communication may occur via an input/output (I/O) interface 35. Furthermore, the electronic device 30 may also communicate with one or more networks (e.g., a Local Area Network (LAN), a Wide Area Network (WAN), and/or a public network, such as the Internet) via a network adapter 36. As shown in the figure, the network adapter 36 communicates with other modules of the electronic device 30 via the bus 33. It should be understood that, although not shown in the figure, other hardware and/or software modules may be used in conjunction with the electronic device 30, including but not limited to: microcode, device drivers, redundant processing units, external disk drive arrays, Redundant Array of Independent Disks (RAID) systems, tape drives, and data backup storage systems, among others.

It should be noted that although the detailed description above mentions several units/modules or sub-units/sub-modules of the electronic device, such division is merely exemplary and not mandatory. In fact, according to the embodiments of the present disclosure, the features and functions of two or more units/modules described above may be embodied in a single unit/module. Conversely, the features and functions of one unit/module described above may be further subdivided and embodied by multiple units/modules.

### Embodiment 4

An embodiment of the present disclosure further provides a computer-readable storage medium having a computer program stored thereon. The computer program implements the model generation method provided in any of the foregoing embodiments when executed by a processor.

Herein, the computer-readable storage medium may specifically include, but is not limited to: a portable disk, a hard disk, a RAM, a ROM, an Erasable Programmable Read-Only Memory (EPROM), an optical storage device, a magnetic storage device, or any suitable combination of the foregoing.

### Embodiment 5

An embodiment of the present disclosure further provides a computer program product, comprising a computer program. The computer program implements the model generation method provided in any of the foregoing embodiments when executed by a processor.

Herein, program code for executing the computer program product of the present disclosure may be written in any combination of one or more programming languages. The program code may be executed entirely on a user device, partly on the user device, as a stand-alone software package, partly on the user device and partly on a remote device, or entirely on the remote device.

Although specific embodiments of the present disclosure have been described above, those skilled in the art should understand that these are merely illustrative, and the protection scope of the present disclosure is defined by the appended claims. Those skilled in the art may make various changes or modifications to these embodiments without departing from the principles and spirit of the present disclosure, but such changes and modifications all fall within the protection scope of the present disclosure.

What is claimed is:

1. A generation method of a model, comprising:
acquiring a plurality of ultrasound images of a target object and corresponding probing position information;
extracting a contour feature point set of the target object in each of the ultrasound images, the contour feature point set comprising a plurality of contour feature points;
obtaining spatial position information of each of the contour feature points based on the contour feature point set corresponding to each of the ultrasound images and the probing position information;
obtaining a target projection point of each of the contour feature points on a standard three-dimensional model corresponding to the target object according to the spatial position information of each of the contour feature points; and
calibrating the standard three-dimensional model based on the spatial position information of each of the contour feature points and the target projection point, to obtain a target three-dimensional model of the target object;
wherein the step of obtaining the target projection point of each of the contour feature points on the standard three-dimensional model corresponding to the target object according to the spatial position information of each of the contour feature points comprises:
acquiring an intersection point set of the contour feature point set corresponding to each of the ultrasound images with the standard three-dimensional model;
aligning the contour feature point set with the corresponding intersection point set using a preset alignment method based on the spatial position information; and
mapping each of the contour feature points in the aligned contour feature point set onto the standard three-dimensional model, to obtain the target projection point corresponding to each of the contour feature points.

2. The generation method according to claim 1, wherein the step of acquiring the intersection point set of the contour feature point set corresponding to each of the ultrasound images with the standard three-dimensional model comprises:
creating a virtual sector surface of the contour feature point set based on the spatial position information and the corresponding probing position information; and
acquiring the intersection point set of the virtual sector surface with the standard three-dimensional model;
wherein the step of aligning the contour feature point set with the corresponding intersection point set using the preset alignment method based on the spatial position information comprises:
acquiring a first centroid position corresponding to the plurality of contour feature points in the contour feature point set, and a second centroid position corresponding to a plurality of intersection points in the intersection point set; and
moving each of the contour feature points in the contour feature point set along the same direction by an identical displacement based on the first centroid position and the second centroid position, to align the contour feature point set with the corresponding intersection point set;
and/or,
wherein the step of mapping each of the contour feature points in the aligned contour feature point set onto the standard three-dimensional model, to obtain the target projection point corresponding to each of the contour feature points comprises:
mapping each of the contour feature points in the contour feature point set onto the standard three-dimensional model, to obtain an initial projection point corresponding to each of the contour feature points;
acquiring a distance between each of the contour feature points and the corresponding initial projection point, to obtain a total distance corresponding to the contour feature point set;
moving each of the contour feature points by an identical preset distance if the total distance does not satisfy a preset condition, to expand or contract the spatial position of each of the contour feature points;
repeating the step of mapping each of the contour feature points in the contour feature point set onto the standard three-dimensional model to obtain the initial projection point corresponding to each of the contour feature points, until the total distance satisfies the preset condition; and
using the initial projection point corresponding to each of the contour feature points as the target projection point.

3. The generation method according to claim 1, wherein the step of calibrating the standard three-dimensional model based on the spatial position information of each of the contour feature points and the target projection point, to obtain the target three-dimensional model of the target object comprises:
acquiring a nearest neighbor point of the target projection point on the standard three-dimensional model;
moving the nearest neighbor point to a position of each of the contour feature points corresponding to the target projection point based on the spatial position information;
acquiring a point set to be updated, the point set to be updated comprising points to be updated whose distance from the nearest neighbor point is less than a preset threshold; and
calibrating each of the points to be updated in the point set to be updated by using a preset algorithm, to obtain the target three-dimensional model.

4. The generation method according to claim 3, wherein the step of calibrating each of the points to be updated in the point set to be updated by using the preset algorithm, to obtain the target three-dimensional model comprises:
acquiring an original point curvature of the standard three-dimensional model;
acquiring a curvature of each of the points to be updated in the point set to be updated, to obtain a calibrated point curvature of the point set to be updated;
calculating a target position of each of the points to be updated using a genetic algorithm that minimizes a difference between the calibrated point curvature and the original point curvature as an optimization objective; and
moving each of the points to be updated to the corresponding target position, to obtain the target three-dimensional model.

5. The generation method according to claim 1, wherein the target object comprises an entire target organ or an entire target tissue;
and/or,
the target object comprises a plurality of target parts comprised in the entire target organ or the entire target tissue;
the contour feature point set of the target object comprises a sub-contour feature point set corresponding to each of the target parts;
wherein the step of obtaining the target projection point of each of the contour feature points on the standard three-dimensional model corresponding to the target object according to the spatial position information of each of the contour feature points comprises:
acquiring all sub-contour feature point sets corresponding to the same target part, and the spatial position information corresponding to the sub-contour feature point set; and
obtaining a sub-projection point of each of sub-contour feature points on a sub-standard three-dimensional model corresponding to the target parts based on the sub-contour feature point set and the spatial position information;
wherein the step of calibrating the standard three-dimensional model based on the spatial position information of each of the contour feature points and the target projection point, to obtain the target three-dimensional model of the target object comprises:
calibrating the sub-standard three-dimensional model corresponding to the target parts based on the spatial position information of each of the sub-contour feature points corresponding to the target parts and the sub-projection point, to obtain a sub-three-dimensional model of each of the target parts; and
obtaining the target three-dimensional model of the target object based on the sub-three-dimensional model of each of the target parts.

6. The generation method according to claim 5, wherein the entire target organ or the entire target tissue comprises a heart; and
each of the target parts comprises a left atrium, a left ventricle, a right atrium, a right ventricle, an aorta, a pulmonary artery, and a superior vena cava.
